(19) United States
(12) Patent Application Publication
(10) Pub. No.: US 2014/0318889 A1
(43) Pub. Date: Oct. 30, 2014

(54) SAFETY SYSTEM FOR A SLANTED ROOF

(71) Applicant: Hans Antonius Borra, Zeist (NL)

(72) Inventor: Hans Antonius Borra, Zeist (NL)

(21) Appl. No.: 14/358,995

(22) PCT Filed: Nov. 16, 2012
(86) PCT No.: PCT/NL2012/050816

§ 371 Date: May 16, 2014

(30) Foreign Application Priority Data
Nov. 17, 2011 (NL) 2007804

(51) Int. Cl. A62B 35/00; E04G 21/32

(52) U.S. Cl. CPC A62B 35/0075; A62B 35/0043; A62B 35/0068; E04G 21/3214
USPC 182/3; 29/428

(57) ABSTRACT

A safety system for a roof, more particularly a pitched roof, comprises an anchor point and a safety line with which a person working on the roof can be secured to the anchor point or an accessory. A first coupling member is attached to or forms part of the anchor point, a second coupling member is attached to or forms part of the safety line or accessory and is suitable for establishing a connection with the first coupling member. Further, the system comprises a mechanism for moving the second coupling member to the first coupling member.

### CROSS-REFERENCE TO RELATED APPLICATION

This Application is a Section 371 National Stage Application of International Application No. PCT/NL2012/050816, filed Nov. 16, 2012 and published as WO 2013/095095 A1 on Jun. 27, 2013, in English.

### BACKGROUND

The discussion below is merely provided for general background information and is not intended to be used as an aid in determining the scope of the claimed subject matter.

The disclosure relates to a safety system, in particular a fall protection system, for a roof, more particularly a pitched roof, comprising an anchor point and a safety line with which a person working on the roof can be secured to the anchor point. The disclosure further relates to a method of attaching a safety line to an anchor point on a (pitched) roof.

In many cases the safety line is provided at one end with a carabiner, which is attached to the anchor point from the eaves, for instance from the point where a ladder is set in position, using a lance. The roofer has to take this, often heavy, lance up with him and reach up high with it, which may cause him/her to lose balance.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

A system by means of which a safety line or an accessory, such as scaffolding or one or more tools or ladders for maintenance or building purposes, can be attached relatively simply and safely to a higher anchor point, for instance to an anchor point on or immediately beneath the ridge of a pitched roof is disclosed.

In one aspect, the system includes a first coupling member attached to or forming part of the anchor point, a second coupling member attached to or forming part of the safety line, in one embodiment an end of the safety line, or accessory and suitable for establishing a connection with the first coupling member, and a means, such as a hoisting line or guide, for moving, e.g. pulling or pushing, the second coupling member to the first coupling member.

In this way the safety line or accessory e.g. can be pulled up with the hoisting line or pushed up along a line or rail from a lower point, such as a point where a ladder is set in position, and a connection established between the coupling members.

In one embodiment the hoisting line, such as a steel cable, is fitted over a run-around, for instance a pin, disc or pulley, on, in or near the anchor point and the hoisting line in one embodiment passes through the first coupling member, so that as the safety line is pulled up, the second coupling member is inherently aligned with the first coupling member.

In a further embodiment the system comprises means for detachably attaching the hoisting line to the second coupling member, in one embodiment on the central axis of the second coupling member.

In a further embodiment the connection is a snap connection, for instance of the type used in pneumatic quick couplers. In that case, apart from pulling or pushing the second coupling member onto the first coupling member, no further actions are required to establish a connection between the first and the second coupling member.

In a further embodiment the connection is maintained when the safety line, at least the exterior of the safety line, is subjected to tensile load. In one embodiment, the second coupling member can comprise an unlocking mechanism for undoing (disconnecting) the connection.

In a further embodiment the safety line comprises a hollow sheath with a cable housed therein which is capable of moving vis-à-vis the sheath and which is connected to the unlocking mechanism. With such a cable the unlocking mechanism can be operated from the other end of the safety line. To this end, the other end of the safety line facing away from the second coupling member can be provided with a control device for moving the cable in the sheath.

Aspects of the invention further relate to a method of attaching a safety line or accessory, such as scaffolding or one or more tools or ladders for maintenance or building purposes, to an anchor point on a roof, more particularly a pitched roof, wherein the safety line or accessory is connected to a hoisting line or guide, is moved with the hoisting line or along guide to the anchor point, and a connection is established between the safety line or accessory and the anchor point.

In one embodiment the anchor point comprises a first coupling member, the safety line or accessory comprises a second coupling member, and the second coupling member is pulled or pushed onto or into the first coupling member, thus establishing a connection.

In a further embodiment the safety line or accessory is lowered down with the hoisting line, after the work on the roof is completed.

In one embodiment, the said actions are performed from the eaves, for instance from a point where a ladder is set in position, before the roofer enters the roof.

Within the framework of the present disclosure “safety line” and “hoisting line” refer to any long, thin and flexible element that is suitable for, respectively, securing a person to an anchor on a roof as described above or hoisting a coupling member and safety line. Examples include cords, lifelines, lanyards, and elements such as (steel) cables and chains, e.g. plastic-coated chains.

### BRIEF DESCRIPTION OF THE DRAWINGS

Aspects of the invention will now be elucidated with reference to the figures, in which an example of the invention is shown.

FIG. 1 is a perspective view of a pitched roof provided with a hoisting line according to aspects of the invention.

FIG. 2 is a perspective view of a pitched roof provided with a hoisting line and a safety line according to the disclosure.

FIG. 3 shows a section across an anchor point and safety line according to aspects of the invention.

FIGS. 4 and 5 are perspective views of a hipped end of a roof provided with anchors according to aspects of the present invention.

### DETAILED DESCRIPTION OF THE ILLUSTRATIVE EMBODIMENTS

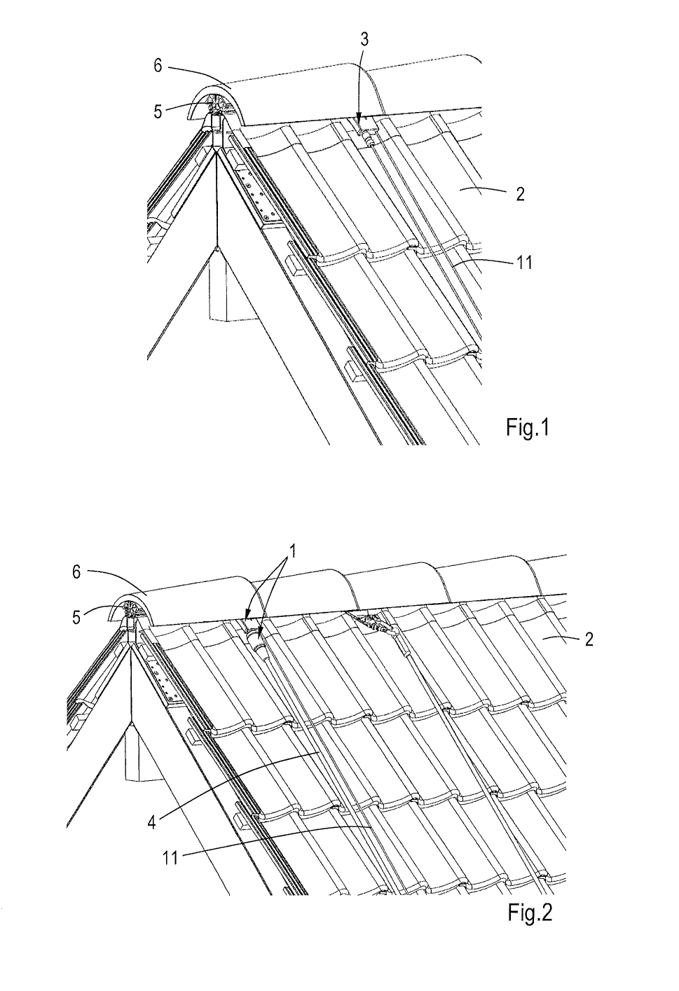

FIGS. 1 and 2 show a fall protection system 1 for use on a pitched roof 2. The system comprises an anchor point 3 and a safety line 4 with which a person working on the roof can be secured to the anchor point 3. In this example the anchor point 3 is movably mounted in a rail 5 located directly beneath the ridge tile 6 of the pitched roof 2.

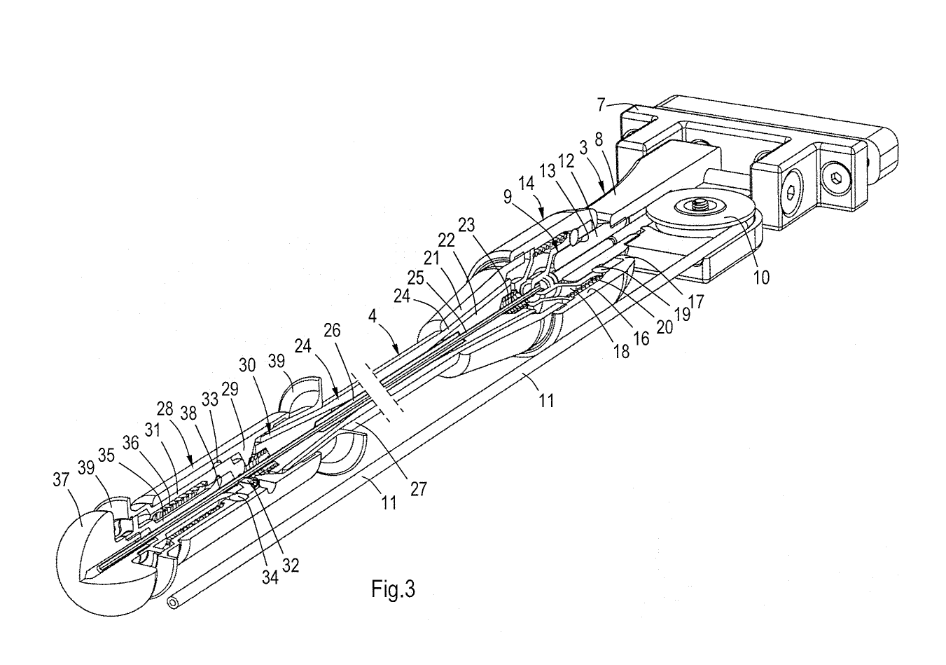

As is shown in the section in FIG. 3, the anchor point 3 comprises a top portion 7 movably housed in the rail 5 and a bottom portion 8 rotatably mounted in the top portion 7. The bottom portion 8 is provided with a first coupling member 9, a pulley 10, and a hoisting line 11, e.g. a steel cable, passing over the pulley 10 and through the coupling member 9. To this end the coupling member is provided with a hollow pin 12 which extends tangentially vis-à-vis the pulley 10 and which is provided with an annular slot 13 around the circumference near the end of the pin.

A second coupling member 14 is attached to one end of the safety line 4 and is suitable for establishing a connection with the first coupling member 9. Within the framework of the disclosure it is preferred that the second coupling member 14 can be pulled or pushed onto the first coupling member 9 and that a snap connection is established in the process, which connection can only be unlocked using a further member, an example of which will be discussed in detail below.

The second coupling member 14 comprises a quick coupler and a rope clamp. The quick coupler in its turn comprises an outer portion or sheath 16, which is provided at one end with an inwards facing edge 17. In the sheath 16 an inner portion or locking bush 18 is housed, which is provided with a number of recesses along its circumference. In each recess a movable member, for instance a bearing ball 19, is housed. The locking bush 18 is forced against the inwards facing edge 17 by means of a spring 20. In this uttermost position the bearing balls 19 are forced inwards by the sheath 16, i.e. in the direction of the central axis of the second coupling member 14. The inner diameter of the sheath 16 increases in proximal direction (i.e., in the direction of the user, away from the first coupling member), so that, when the second coupling member 14 is pulled onto the first coupling member 9, the locking bush 18 in the second coupling member 14 is pushed inwards through the hollow pin 12 of the first coupling member 9, the bearing balls 19 can recede outwards (away from the central axis), and the end of the pin 12 can pass the bearing balls 19. When the bearing balls 19 reach the annular slot 13 around the pin 12, the locking bush 18 is forced upwards by the spring 20 and the bearing balls 19 slip inside, i.e. into the annular slot 13. This snap connection can only be undone by pulling the locking bush 18 back vis-à-vis the sheath 16, against the action of the spring 20. Pulling or pushing on the sheath 16 cannot result in the connection being undone.

The rope clamp which is part of the second coupling member 14 comprises an outer portion 21 with a conical bore of which the inner diameter increases in distal direction (away from the user). In the bore there is an also conical bush 22, which is forced in proximal direction with a spring 23 and which is provided with a central, cylindrical bore.

In this example the safety line 4 comprises a hollow sheath 24 in which a cable 25 is housed, which can move vis-à-vis the sheath 24 in longitudinal direction. The cable is made for instance of steel. The sheath 24 is composed for instance of an inner hollow wound spiral 26 made of steel wire with a protective covering of plastic or braided cord 27 around it.

The sheath 24 of the safety line 4 is clamped between the outer portion 21 and the conical bush 22 and the cable 25 is passed through the central bore and clamped in the locking bush 18.

Behind the locking bush 18 or, as in the example shown, inside the locking bush 18 an internal screw thread 26 is fitted, so that the end of the hoisting line 11, provided with an external screw thread, can be screwed into the second coupling member 14 and unscrewed again after use.

The end of the safety line 4 facing away from the second coupling member 14 is provided with a rope clamp, which basically matches the rope clamp in the second coupling member, and a control device 28 for moving the cable 25 in the sheath 24. In this example the control device 28 comprises a housing 29 in which a rope clamp 30, a bush 31, and a locking mechanism are mounted. The remaining end of the cable 25 is firmly secured in the bush 31, for instance by means of a clamp or radial screw 32. The locking mechanism comprises an annular slot 33 in the inner wall of the housing 29. The bush 31 is provided with a number of recesses along its circumference, in each of which a movable member, for instance a bearing ball 34, is housed. Inside the bush 31 there is a pin 35, which is forced in proximal direction (outwards) by a spring 36 and which is provided with a push button 37 with which the pin 35 can be forced inwards by a user, counter to the action of the spring 36. The (distal) end of the pin 34 has a thickening 38, which forces the bearing balls 34 outwards and into the annular slot 33. When the push button 37 is pushed in, the radial locking of the bearing balls 34 is undone, so that as the bush 31 is pulled outwards, these bearing balls 34 are able to move radially into and out of the annular slot 33.

The housing 29 and the unlocking bush 31 are both provided with a flange 39, in order to facilitate the pulling outwards of the bush 31 and the cable 25 and thus the undoing of the connection between the first and the second coupling member 9, 14.

The fall protection system is used as follows. A roofer sets a ladder in position against the eaves at the point where the hoisting line is located and climbs up with a safety line. At the top of the ladder or standing on the eaves, the roofer secures one end of the hoisting line in the coupling member of the safety line. Next, he pulls the safety line up with the hoisting line and, finally, the second coupling member onto the first coupling member, in which process a connection (coupling) is established. Next, the roofer connects his harness to the safety line. The roofer can now move safely on and along the roof with the anchor point following him. The fall factor and the pendulum effect are minimal or zero. When he has completed his work, he returns to the ladder and undoes the connection. Next, he lowers the safety line with the hoisting line and climbs down via the ladder.

The fall protection system according to the disclosure can be connected and disconnected relatively quickly, safely, and simply. Moreover, in the case of a suitable hoisting line selection, in particular in terms of diameter and color, the system is hardly visible if at all, i.e. it has no or hardly any effect on the appearance of the roof. In an

[symbol]

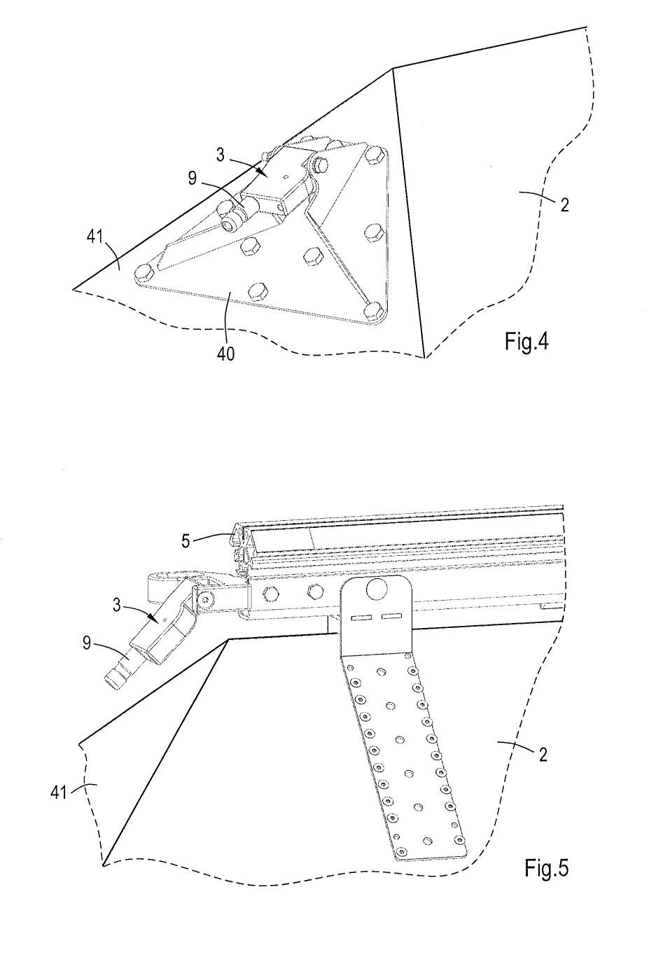

FIGS. 4 and 5 show embodiments comprising a fixed anchor point 3. In these examples, the anchor point comprises a mounting plate 40 attached, e.g. bolted, directly to the hipped end 41 of a pitched roof (FIG. 4) or it is fixedly attached to one of the ends of a rail 5 mounted on the ridge of roof (FIG. 5).

Hipped ends of roofs are usually provided with a plurality of hooks, which may affect the appearance of the roof and/or require annual inspection. An anchor point according to the present invention may replace all or at least a plurality of such hooks. Further, at least if the anchor point is attached at or near the apex of the hipped end of the roof, in case of a fall, hazardous pendulum effects are reduced or avoided altogether.

The invention is not limited to the described embodiments and can be varied within the framework of the claims.

1. A safety system for a roof comprising:
an anchor point,
a safety line with which a person working on the roof can be secured to the anchor point or an accessory,
a first coupling member attached to or forming part of the anchor point,
a second coupling member attached to or forming part of the safety line or accessory and configured to establish a connection with the first coupling member, and
a hoisting line configured to move the second coupling member to the first coupling member.

2. The system according to claim 1, wherein the hoisting line is fitted over a run-around on, in or near the anchor point.

3. The system according to claim 1, wherein the hoisting line passes through the first coupling member.

4. The System according to claim 1, and further comprising:
a connection configured to detachably attach the hoisting line to the second coupling member.

5. The system according to claim 4, wherein the connection comprises a snap connection.

6. The system according to claim 4, wherein the connection is configured to be maintained when the safety line or accessory is subjected to tensile load.

7. The system according to claim 1, wherein the second coupling member comprises an unlocking mechanism configured to undo the connection.

8. The system according to claim 7, wherein the safety line comprises a hollow sheath in which a cable is housed which is configured to move vis-à-vis the sheath and which is connected to the unlocking mechanism.

9. The system according to claim 8, wherein the end of the safety line facing away from the second coupling member is provided with a control device configured to move the cable in the sheath.

10. The system according to claim 9, wherein the control device is provided with a locking mechanism configured to prevent the connection between the coupling members from being undone by the control device by mistake.

11. A method of attaching a safety line or accessory to an anchor point on a roof, the method comprising:
connecting the safety line or accessory to a hoisting line or a guide,
moving the safety line with the hoisting line or along the guide to the anchor point, and
establishing a connection between the safety line or accessory and the anchor point.

12. The method according to claim 11, wherein the anchor point comprises a first coupling member and the safety line or accessory comprises a second coupling member, wherein moving the safety line with the hoisting line comprises:
pushing or pulling the second coupling member onto or into the first coupling member with the hoisting line.

13. The method according to claim 11, and further comprising:
lowering the safety line or accessory with the hoisting line or guide after the work on the roof is completed.

14. The method according to claim 10 and wherein the afore-mentioned actions are performed from eaves.
